(19) United States
(12) Patent Application Publication
(10) Pub. No.: US 2022/0305419 A1
(43) Pub. Date: Sep. 29, 2022

(54) MODULAR FILTER ELEMENT FOR HOT GAS FILTRATION

(71) Applicant: MADISON FILTER 981 LIMITED, Staffordshire (GB)

(72) Inventors: Elgin OKTAY, Ohringen (DE); Detlef HEGA, Bad Gandersheim (DE); Purv PUROHIT, Berlin (DE)

(73) Assignee: MADISON FILTER 981 LIMITED, Staffordshire (GB)

(21) Appl. No.: 17/620,012

(22) PCT Filed: Jun. 17, 2020
(86) PCT No.: PCT/GB2020/051463

§ 371 Date: Dec. 16, 2021

(30) Foreign Application Priority Data
Jun. 19, 2019 (GB) 1908793.1

(51) Int. Cl. B01D 46/24; B01D 46/00

(52) U.S. Cl. CPC B01D 46/2407; B01D 46/0005; B01D 2273/20; B01D 2265/06

(57) ABSTRACT

A modular filter element that has a first elongate hollow body and a second elongate hollow, where a female portion extends axially into a wall of one of the elongate hollow bodies and a male portion extends axially from the other elongate hollow body into the female portion to connect the first elongate hollow body to the second elongate hollow body is disclosed.

### TECHNICAL FIELD OF THE INVENTION

The present invention relates to a modular filter element, to a method of producing the modular filter element, to an exterior support structure for the modular filter element, to a method of installing the modular filter element in a filter housing, to a filtration apparatus comprising the modular filter element and to the use of the modular filter element for filtering particulate matter from high temperature gas streams.

### BACKGROUND TO THE INVENTION

Hot gas filtration is a process by which particulate matter is filtered from gas streams that typically have a temperature between 200° C. and 900° C. Ceramic filter elements are often used instead of traditional textile filter elements to remove particulates from hot gas streams since they exhibit superior filtration characteristics and do not substantially degrade at higher temperatures. Most commercially available single piece ceramic filter elements are available in lengths of up to 4.5 metres. However, it becomes increasingly difficult to manufacture, store, transport, handle and to fit the filter elements to filter housings when the length of the filter element exceeds 3 metres, and in applications where thousands of filter elements may be needed, the filter plant footprint and its cost also becomes prohibitive.

Modular filter elements formed from multiple filter element sub-sections are known in the art and were developed to overcome or at least alleviate some of the above-mentioned problems. One known modular filter element utilises a screw connection to join adjacent filter element sub-sections together. However, such filter elements suffer from the disadvantage that they are expensive to manufacture due to the machining involved in forming the screw threads, e.g., it is particularly difficult to machine the screw threads without forming cracks during the machining operation. Moreover, due to the nature of the connection, such modular filter elements suffer from sealing issues which can lead to a reduction in filtration performance. Filter elements are also known to vibrate in use and therefore there is a risk of the filter element sub-sections becoming partly or fully unscrewed. It will be appreciated that if filter element sub-sections become partly unscrewed then filtration performance will decline due to the absence of a gas tight seal. However, in more severe cases where the filter element sub-sections become fully unscrewed, the filter element sub-section below the joint may fall into a collection hopper thereby contaminating any filtered particulate matter in the hopper. Contamination of the particulate matter is undesirable, especially when the filtered particulate matter is valuable, and may result in it having to be discarded and/or the filtering operation being halted while the filter element sub-section is removed from the hopper.

In light of the above it is an object of embodiments of the invention to provide a modular filter element that enables a secure connection between two filter element sub-sections to be obtained.

It is also an object of embodiments of the present invention to provide a modular filter element that is less expensive and time consuming to manufacture.

It is a further object of embodiments of the present invention to provide a modular filter element that is more than 3 metres in length.

It is another object of embodiments of the present invention to provide a support structure and method which prevents bending and inconcentric installation of the modular filter element in a filter housing.

### SUMMARY OF THE INVENTION

According to a first aspect of the invention there is provided a modular filter element which comprises a first elongate hollow body and a second elongate hollow body, wherein a female portion extends axially into a wall of one of the elongate hollow bodies and a male portion extends axially from the other elongate hollow body into the female portion to connect the first elongate hollow body to the second elongate hollow body. A benefit of the arrangement according to the first aspect of the invention is that the ends of adjacent elongate hollow bodies don't overlap which enables improvements in filtering efficiency to be obtained while ensuring a robust and reliable connection between adjacent elongate hollow bodies.

The female portion may be substantially horse-shoe shaped.

In some embodiments the male portion may be inserted into the female portion so that the female portion surrounds the edge of the male portion in use.

In some embodiments the female portion and the male portion may be configured to provide an interference-fit connection. In particular, the female portion and the male portion may be configured to provide a push-fit or press-fit connection.

One of the elongate hollow bodies may comprise at least two female portions and the other elongate hollow body may comprise a corresponding number of male portions. It has been found that a strong connection can be obtained when one of the elongate hollow bodies comprises two female portions and the other elongate hollow body comprises two axially extending male portions.

The female portion and the male portion are preferably free from screw threads. This has the benefit that known machining, sealing and reliability issues associated with modular filter elements comprising one or more screw connections are avoided or at least ameliorated.

An adhesive may be located at the interface between the first and second elongate hollow bodies. The adhesive may comprise a ceramic or ceramic based adhesive. It has been found that the strength of the connection between the first and second elongate hollow bodies is improved when an adhesive is provided at the interface between the first and second elongate bodies. The presence of the adhesive at the interface also helps to ensure that a gas tight seal is formed between the first and second elongate hollow bodies.

In some embodiments webbing may be wrapped around the first and second elongate hollow bodies in the region of the connection to help form an air tight seal. The webbing may be in the form an adhesive tape. The webbing may be secured to the first and second elongate hollow bodies using an adhesive. The adhesive may be the adhesive used to join the first and second elongate hollow bodies together or it may be a different adhesive.

The length of the modular filter element may be between 3 and 8 metres. For example, the length of the modular filter element may be, 3.5 metres, 4 metres, 4.5 metres, 5 metres, 5.5 metres, 6 metres, 6.5 metres, 7 metres or 7.5 metres. In some embodiments the length of the first elongate hollow body may be greater than the length of the second elongate hollow body. Such an arrangement helps to reduce the extent to which the modular filter element bends during installation and in use. In a preferred embodiment where the modular filter element has a length of 4.5 metres, the length of the first and second elongate hollow bodies may be 2.9 metres and 1.6 metres respectively.

In one embodiment of the invention, the modular filter element is a two-piece filter element comprising the first and second elongate hollow bodies. In other embodiments filter elements may comprise three or more elongate hollow bodies. In particular, the filter element may be a three-piece filter element or a four-piece filter element. For instance, one or more intermediate elongate hollow bodies may be provided between the first elongate hollow body and second elongate hollow body to increase the length of the modular filter element. The intermediate elongate hollow bodies may be open at their respective ends and joined together in the same way as described above, i.e. through interconnection of a female portion and a complimentary axially extending male portion. The upper and lower ends of the intermediate hollow bodies may be flangeless.

The modular filter element may comprise an exterior support structure to prevent bending of the modular filter element. In particular, the exterior support structure may comprise a rod and means for securing the modular filter element to the rod. The securing means may comprise a single clamp or a plurality of clamps spaced along the rod. Such an arrangement has the benefit that the support structure is relatively light and helps to prevent against inconcentric installing of the modular filter element in the filter housing. The clamps may be in the form of adjustable clamping bands.

In some embodiments the means for securing the modular filter element to the rod may comprise a wire or a plurality of wires. The wire or wires may be formed from a metal or metal alloy.

The exterior support structure may be formed from a metal or a metal alloy. The support structure may for example be formed from steel.

The exterior support structure may extend at least partly along the length of the modular filter element. For example, the exterior support structure may extend from the bottom of the modular filter element and terminate in a region close to the top of the modular filter element.

The exterior support structure may comprise a means for centering the modular filter element during its installation into a filter housing. The centering means may comprise a ring member. The ring member may be located in a lower region of the exterior support structure, preferably at its base. The ring member may be configured so that it can be opened and closed. For example, the ring member may be formed from two ring halves which are hinged together.

The first elongate hollow body may comprise a flange which is arranged to enable mounting of the modular filter element to the filter housing of a filtration apparatus. Since the modular filter element is normally formed from a ceramic material, the flange may be integral with the first elongate hollow body and be formed from a ceramics material. The ceramic flange may be provided with a metallic plate for strengthening and protecting the ceramic flange during use. The metallic plate may cover all or part of an outer surface of the ceramic flange. In some embodiments the metallic plate may be formed from a metal alloy such as steel. In particular the metallic plate may be formed from stainless steel or from coated mild steel.

In some embodiments the modular filter element may comprise a carrier. In particular, the carrier may comprise a collar that is adapted to engage with the flange and a handle attached to the collar. The collar may be a sprung collar. Alternatively, the carrier may comprise a plug adapted for insertion into the first elongate body. In some embodiments the plug may comprise a member that enables the modular filter element to be carried. For example, the plug may comprise a T-shaped member or a V-shaped member.

The filter element may be formed from a ceramic material, a ceramic based material or from mineral fibres. In some embodiments the filter element may comprise a catalyst. The catalyst may be any catalyst that is capable of removing gaseous contaminants from a gas stream. In particular, the catalyst may enable acid gases, NOx and dioxins to be simultaneously removed from a gas stream by selective catalytic reduction.

The modular filter element may comprise an internal support in the form of a metallic cage so that the modular filter element can withstand greater lateral loads when clamped in the filter housing.

According to a second aspect of the invention there is provided a method of producing a modular filter element according to the first aspect of the invention, the method comprising the steps of:
providing, a first elongate hollow body and a second elongate hollow body, wherein a female portion extends axially into a wall of one of the elongate hollow bodies and a male portion extends axially from the other elongate hollow body, and
inserting the male portion into the female portion to secure the first elongate hollow body to the second elongate hollow body.

The method according to the second aspect of the invention may incorporate any or all of the features described in relation to the modular filter element according to first aspect of the invention as desired or as appropriate.

The method may comprise the step of applying an adhesive at the interface between the first elongate hollow body and the second elongate hollow body. Accordingly, the adhesive may be applied on the first elongate hollow body and/or on the second elongate hollow body. The adhesive may be a ceramic cement adhesive, e.g. when the filter element is formed from a ceramic material.

According to a third aspect of the invention there is provided a filtration apparatus comprising the modular filter element according to the first aspect of the invention. The filtration apparatus of the third aspect of the invention may incorporate any or all of the features described in relation to the modular filter element according to first aspect of the invention as desired or as appropriate.

According to a fourth aspect of the invention there is provided a support structure for preventing bending of a filter element, the support structure comprising a rod, means for attaching the modular filter element to the rod and means for centering the modular filter element during its installation into a filter housing. The support structure according to the fourth aspect of the invention may incorporate any or all of the features described in relation to the modular filter element according to first aspect of the invention as desired or as appropriate.

According to a fifth aspect of the invention there is provided a method of installing a filter element in a filter housing, the method comprising the steps of:
providing a filter element;
securing the filter element to an exterior support structure;
centering the filter element with respect to an opening in the filter housing adapted to receive the filter element, and
lowering the filter element into the filter housing through the opening.

The method according to the fifth aspect of the invention may incorporate any or all features of the modular filter element according to the first aspect of the invention or any or all features according to the support structure according to the fourth aspect of the invention as desired or as appropriate.

The method may comprise the step of attaching a carrier to the first elongate hollow body to facilitate lowering of the modular filter element into the filter housing.

According to a sixth aspect of the invention there is provided a use of the modular filter element according to the first aspect of the invention for filtering particulate matter from hot gas streams. The use of the modular filter element according to the may incorporate any or all of the features described in relation to the first aspect of the invention as desired or as appropriate.

### DETAILED DESCRIPTION OF THE INVENTION

In order that the invention may be more clearly understood one or more embodiments thereof will now be described, by way of example only, with reference to the accompanying drawings, of which:

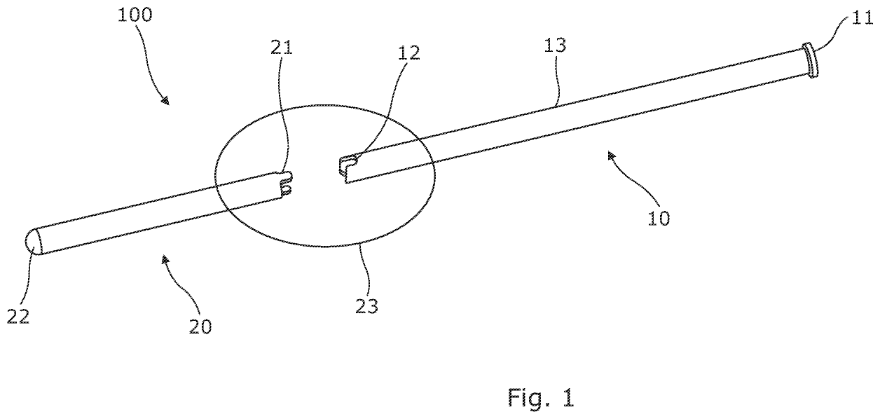

FIG. 1 shows a perspective view of a modular filter element;

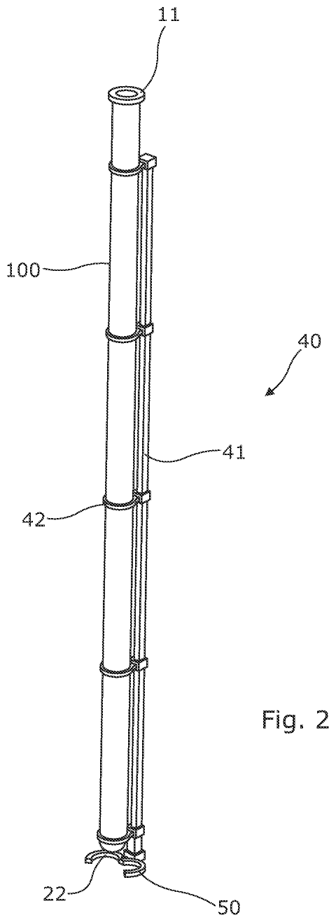

FIG. 2 shows a perspective view of an exterior support structure supporting the modular filter element shown in FIG. 1;

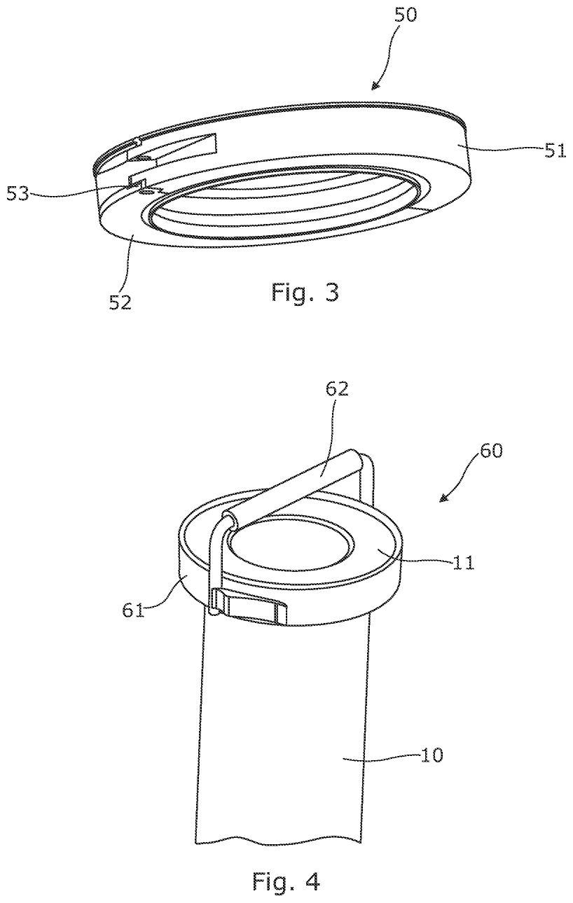

FIG. 3 shows a perspective view of a ring member for centering the modular filter element shown in FIG. 1;

FIG. 4 shows a perspective view of a carrier installed on the modular filter element shown in FIG. 1;

With reference to FIG. 1, and in accordance with an example of the present invention there is provided a ceramic filter element 100 for filtering particulate matter from hot gas streams. The modular filter element 100 comprises a first elongate hollow body 10 formed from a ceramic material having a length of about 2.9 metres and an external diameter of between 140 and 160 mm. The first elongate hollow body 10 has a substantially tubular profile. The first elongate hollow body 10 comprises a flange 11 at one end which is configured to enable mounting of the filter element 100 to a filter housing (not shown). At the opposite end there are two female portions 12 formed in the wall 13 that extends between the ends of the first elongate hollow body 10. The female portions 12 have a substantially horseshoe shaped profile. A metallic plate (not shown) is used to reinforce the flange 11 since this area of the modular filter element 100 is known to be susceptible to fracturing. As shown in FIG. 1, the end of the first elongate hollow body 10 comprising the female portions 12 is open.

The modular filter element 100 also comprises a second elongate hollow body 20. The second elongate hollow body 20 is about 1.6 metres in length and has an external diameter of between 140 and 160 mm. The second elongate hollow body 20 is formed from a ceramic material and has a substantially tubular profile. In particular, the second elongate hollow body 20 comprises two male portions 21 which extend axially from one end of the second elongate hollow body 20. The male portions 21 are arranged to frictionally engage with the female portions 12 of the first elongate hollow body 10 to form an interference fit connection. This connection (without adhesive) is able to withstand an axial force which is more than sufficient to carry the remainder of the filter element. FIG. 1 also shows that the end 22 of second elongate hollow body 20 opposite the end comprising the male portions 21 is closed.

A ceramic based adhesive (not shown) is provided at the interface 23 between the first elongate hollow body 10 and the second elongate hollow body 20 in order to strengthen the connection between the first elongate hollow body 10 and the second elongate hollow body 20. A tape (not shown) may be wrapped around the first and second elongate hollow bodies in the region of the interference fit connection to help form an air tight seal.

FIG. 2 shows an exterior support structure 40 for the modular filter element 100 which helps to prevent the modular filter element 100 from bending from being inconcentrically installed in the filter housing of a filter apparatus. The exterior support structure 40 comprises a metallic rod 41 and a plurality of clamping bands 42 spaced along the rod 41. The clamping bands 42 are adjustable and are configured to fit around and hold the modular filter element 100 in place prior to its installation into the filter housing. As best shown in FIG. 3, a ring member 50 is located at the base of the exterior support structure 40 to help centre the modular filter element 100 as it is lowered into the filter housing. The ring member 50 itself is formed from two ring halves 51, 52 which are held together by way of a hinge connection 53. In this way the ring member 50 can be opened and closed as needed.

To facilitate installation of the modular filter element 100 into the filter housing, the modular filter element 100 is provided with a carrier 60 (FIG. 4). The carrier 60 comprises a hinged collar 61 which is configured to fit around and the flange 11 of the first elongate hollow body 10. An n-shaped handle 62 is pivotally attached to the exterior of the collar 61 so that the modular filter element 100 can be lifted and lowered into the filter housing easily and quickly. The collar 61 is formed from a metal alloy such as steel.

To install the modular filter element 100 in a filter housing of a filtration apparatus the clamping bands 42 and the ring member 50 of the exterior support structure 40 are opened in readiness to receive the modular filter element 100. The modular filter element 100 is then positioned within the clamping bands 42 which are then tightened to temporarily secure the modular filter element 100 to the exterior support structure 40. The exterior support structure 40 and modular filter element 100 are then carried to the filter housing using carrier 60. The ring member 50 is then closed around a flange portion of the filter housing. This secures the exterior support structure 40 to the filter housing and also ensures that the modular filter element 100 is properly centred above the opening in the filter housing. The clamping bands 42 are then loosened so that that modular filter element can be lowered, with the aid of the carrier, into the opening of the filter housing.

The one or more embodiments are described above by way of example only. Many variations are possible without departing from the scope of protection afforded by the appended claims.

1: A modular filter element which comprises a first elongate hollow body and a second elongate hollow, wherein a female portion extends axially into a wall of one of the elongate hollow bodies and a male portion extends axially from the other elongate hollow body into the female portion to connect the first elongate hollow body to the second elongate hollow body.

2: A modular filter element according to claim 1, wherein the female portion is substantially horse-shoe shaped.

3: A modular filter element according to claim 1, wherein the female portion and male portion are configured to provide an interference-fit connection.

4: A modular filter element according to claim 1, wherein an adhesive is located at the interface between the first and second elongate bodies.

5. (canceled)

6: A modular filter element according to claim 1, wherein a webbing material is wrapped around the first and second elongate hollow bodies in the region of the connection.

7: A modular filter element according to claim 1, wherein one of the elongate hollow bodies comprises at least two female portions and the other elongate hollow body comprises a corresponding number of male portions.

8-9. (canceled)

10: A modular filter element according to claim 1, wherein the modular filter element comprises an exterior support structure to prevent bending of the modular filter element in use.

11: A modular filter element according to claim 10, wherein the exterior support structure extends at least partly along the length of the modular filter element.

12: A modular filter element according to claim 10, wherein the exterior support structure comprises a rod and means for securing the modular filter element to the rod.

13: A modular filter element according to claim 12, wherein the means for securing the modular filter element to the rod comprises one or more clamps or one or more wires.

14: A modular filter element according to claim 10, wherein the exterior support structure comprises means for centering the modular filter element during its installation into a filter housing.

15: A modular filter element according to claim 14, wherein the means for centering the modular filter element comprises a ring member.

16: A modular filter element according to claim 15, wherein the ring member is configured to be opened and closed.

17. (canceled)

18: A modular filter element according to claim 1, wherein the modular filter element comprises a carrier.

19: A modular filter element according to claim 18, wherein the carrier comprises a collar adapted to engage with the flange and a handle attached to the collar.

20: A modular filter element according to claim 18, wherein the carrier comprises a plug adapted for insertion into the first elongate body and a member connected to the plug for carrying the modular filter element.

21: A method of producing a modular filter element according to claim 1, the method comprising the steps of:
providing, a first elongate hollow body and a second elongate hollow body, wherein a female portion extends axially into a wall of one of the elongate hollow bodies and a male portion extends axially from the other elongate hollow body, and
inserting the male portion into the female portion to secure the first elongate hollow body to the second elongate hollow body.

22. (canceled)

23: A support structure for preventing bending of a filter element, the support structure comprising a rod, means for attaching the modular filter element to the rod and means for centering the modular filter element during its installation into a filter housing, wherein the means for centering the modular filter element comprises a ring member that is configured to be opened and closed.

24: A method of installing a modular filter element in a filter housing, the method comprising the steps of:
providing a filter element;
securing the filter element to the exterior support structure according to claim 23;
centering the filter element with respect to an opening in the filter housing adapted to receive the filter element, and lowering the filter element into the filter housing through the opening.

25: A method according to claim 24, wherein the method comprises the step of attaching a carrier to the first elongate hollow body to facilitate lowering of the modular filter element into the filter housing.
